(19) United States
(12) Patent Application Publication
(10) Pub. No.: US 2020/0172099 A1
(43) Pub. Date: Jun. 4, 2020

(54) VEHICLE AND METHOD OF CONTROLLING THE SAME

(71) Applicants: Hyundai Motor Company, Seoul (KR); Kia Motors Corporation, Seoul (KR)

(72) Inventors: JinHa CHOI, Suwon-Si (KR); Cheolhyeon KWON, Suwon-si (KR)

(73) Assignees: Hyundai Motor Company, Seoul (KR); Kia Motors Corporation, Seoul (KR)

(21) Appl. No.: 16/540,339

(22) Filed: Aug. 14, 2019

(30) Foreign Application Priority Data
Nov. 29, 2018 (KR) 10-2018-0150446

(51) Int. Cl. B60W 30/095; B60W 30/12; G05D 1/00; G06K 9/00; G08G 1/16

(52) U.S. Cl. CPC B60W 30/0956; B60W 30/12; G08G 1/167; G05D 1/0061; G06K 9/00825; G05D 1/0088

(57) ABSTRACT

A vehicle may include a communicator; a storage configured to store map information; a detecting device configured to detect driving information related to the vehicle and surrounding information related to the vehicle; and a controller configured to: determine a predicted position of the vehicle based on the map information, the driving information, and the surrounding information; determine a precise position based on the predicted position and a position signal received through the communicator; and control the vehicle to make a driving that reduces the difference between the predicted position and the precise position.

### CROSS-REFERENCE TO RELATED APPLICATION(S)

The present application claims priority to Korean Patent Application No. 10-2018-0150446, filed on Nov. 29, 2018 in the Korean Intellectual Property Office, the entire contents of which is incorporated herein for all purposes by this reference.

### BACKGROUND OF THE INVENTION

### Field of the Invention

Embodiments of the disclosure relate to a vehicle for determining a position of the vehicle using surrounding information, and a method of controlling the vehicle.

### Description of Related art

In the case of an autonomous driving vehicle based on precise maps, recognition of a position of the vehicle using map information is a first step to be performed, and an accuracy of position recognition affects a performance of the vehicle control.

A positioning technology for autonomous driving may be a method of matching a current position of the vehicle with a position of a map by utilizing surrounding information. In general, the more accurately information related to the surrounding object is measured, the more accurate information may be obtained.

On the other hand, when accurate information cannot be obtained, the correction may be performed using a filter or the like only with the obtained information. However, if an error value is more than a certain value, a reliability thereof is lowered, which may make it difficult to perform safe autonomous driving of the vehicle.

Therefore, studies regarding technologies for determining a precise position of the vehicle are being vigorously conducted.

The information included in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a vehicle configured for precisely determining a position of a vehicle through a driving path leading to accurate positioning of the vehicle and configured for safe autonomous driving, and a method of controlling the vehicle.

Additional aspects of the disclosure will be set forth in part in the description which follows and, in part, will be obvious from the description, or may be learned by practice of the disclosure.

In accordance with an aspect of the disclosure, a vehicle may include a communicator; a storage configured to store map information; a detecting device configured to detect driving information related to the vehicle and surrounding information related to the vehicle; and a controller configured to: determine a predicted position of the vehicle based on the map information, the driving information, and the surrounding information; determine a precise position based on the predicted position and a position signal received through the communicator; and control the vehicle to make a driving that reduces the difference between the predicted position and the precise position.

The controller may be configured to control the vehicle to follow a reference element of the surrounding information based on the difference between the predicted position and the precise position and the position signal.

The controller may be configured to control the driving of the vehicle following a surrounding vehicle driving around the vehicle based on the difference between the predicted position and the precise position; and determine at least one of the predicted position or the precise position based on a positional relationship between the vehicle and the surrounding vehicle.

The controller may be configured to determine a position of a fixture included in the reference element based on at least one of the map information or the position signal; and control the vehicle to follow the fixture and make the driving that reduces the difference between the predicted position and the precise position.

The controller may be configured to determine road characteristics around the vehicle based on at least one of the map information or the position signal; and control the vehicle to follow a lane in which a predetermined road characteristic exists and make the driving that reduces the difference between the predicted position and the precise position.

The vehicle may further include an inputter configured to input a driver's command. The controller may be configured to control the vehicle to make the driving that reduces the difference between the predicted position and the precise position when it is determined that control rights of the vehicle is changed based on the driver's command.

The controller may be configured to control the vehicle to make the driving that reduces the difference between the predicted position and the precise position when an intensity of a signal received by the communicator is less than a predetermined value.

The controller may be configured to control the vehicle to make the driving that reduces the difference between the predicted position and the precise position when an obtained amount of a reference element which is a reference for determining the surrounding information is less than a predetermined value.

The controller may be configured to determine position information related to the vehicle based on the predicted position and the precise position.

In accordance with another aspect of the disclosure, a method of controlling a vehicle may include obtaining, by a detecting device, surrounding information related to the vehicle; determining, by a controller, a predicted position of the vehicle based on map information and the surrounding information; determining, by the controller, a precise position based on the predicted position and a received position signal; and controlling, by the controller, the vehicle to make a driving that reduces the difference between the predicted position and the precise position.

The controlling of the vehicle to make a driving that reduces the difference between the predicted position and the precise position may include controlling the vehicle to follow a reference element of the surrounding information based on the difference between the predicted position and the precise position and the position signal.

The controlling of the vehicle to make a driving that reduces the difference between the predicted position and the precise position may include controlling the driving of the vehicle following a surrounding vehicle driving around the vehicle based on the difference between the predicted position and the precise position. The determining of the precise position based on the predicted position and the received position signal may include determining at least one of the predicted position or the precise position based on a positional relationship between the vehicle and the surrounding vehicle.

The controlling of the vehicle to make a driving that reduces the difference between the predicted position and the precise position may include determining a position of a fixture included in the reference element based on at least one of the map information or the position signal; and controlling the vehicle to follow the fixture and make the driving that reduces the difference between the predicted position and the precise position.

The controlling of the vehicle to make a driving that reduces the difference between the predicted position and the precise position may include determining road characteristics around the vehicle based on at least one of the map information or the position signal; and controlling the vehicle to follow a lane in which a predetermined road characteristic exists and make the driving that reduces the difference between the predicted position and the precise position.

The method may further include inputting a driver's command. The controlling of the vehicle to make a driving that reduces the difference between the predicted position and the precise position may include controlling the vehicle to make the driving that reduces the difference between the predicted position and the precise position when it is determined that control rights of the vehicle is changed based on the driver's command.

The controlling of the vehicle to make a driving that reduces the difference between the predicted position and the precise position may include controlling the vehicle to make the driving that reduces the difference between the predicted position and the precise position when an intensity of a signal received by the communicator is less than a predetermined value.

The controlling of the vehicle to make a driving that reduces the difference between the predicted position and the precise position may include controlling the vehicle to make the driving that reduces the difference between the predicted position and the precise position when an obtained amount of a reference element which is a reference for determining the surrounding information is less than a predetermined value.

The method may further include determining position information related to the vehicle based on the predicted position and the precise position.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a control block diagram of a vehicle according to an exemplary embodiment of the present invention;

FIG. 2 is a view for describing an operation of obtaining position information related to a driving vehicle;

FIG. 3 is a block diagram for describing an operation of deriving a predicted position and a precise position according to an exemplary embodiment of the present invention;

FIG. 4 is a view for describing an operation of deriving the difference between a predicted position and a precise position according to an exemplary embodiment of the present invention;

FIG. 5, FIG. 6, FIG. 7, and FIG. 8 are views for describing a driving operation for reducing the difference between a predicted position and a precise position; and

FIG. 9 is a flowchart according to an exemplary embodiment of the present invention.

It may be understood that the appended drawings are not necessarily to scale, presenting a somewhat simplified representation of various features illustrative of the basic principles of the present invention. The specific design features of the present invention as included herein, including, for example, specific dimensions, orientations, locations, and shapes will be determined in part by the particularly intended application and use environment.

In the figures, reference numbers refer to the same or equivalent portions of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

Like reference numerals refer to like elements throughout the specification. Not all elements of the exemplary embodiments of the disclosure will be described, and the description of what are commonly known in the art or what overlap each other in the exemplary embodiments will be omitted. The terms as used throughout the specification, such as “˜part,” “˜module,” “˜member,” “˜block,” etc., may be implemented in software and/or hardware, and a plurality of “˜parts,” “˜modules,” “˜members,” or “˜blocks” may be implemented in a single element, or a single “˜part,” “˜module,” “˜member,” or “˜block” may include a plurality of elements.

It will be further understood that the term “connect” and its derivatives refer both to direct and indirect connection, and the indirect connection includes a connection over a wireless communication network.

The term “include (or including)” and “comprise (or comprising)” are inclusive or open-ended and do not exclude additional, unrecited elements or method steps, unless otherwise mentioned.

It will be further understood that the term “member” and its derivatives refer both to when a member is in contact with another member and when another member exists between the two members.

It will be understood that, although the terms first, second, third, etc., may be used herein to describe various elements, components, regions, layers and/or sections, these elements, components, regions, layers and/or sections may not be limited by these terms. These terms are only used to distinguish one element, component, region, layer or section from another region, layer or section.

It is to be understood that the singular forms “a,” “an,” and “the” include plural references unless the context clearly dictates otherwise.

Reference numerals used for method steps are merely used for convenience of explanation, but not to limit an order of the steps. Thus, unless the context clearly dictates otherwise, the written order may be practiced otherwise.

Hereinafter, an operation principle and embodiments of the disclosure will be described with reference to accompanying drawings.

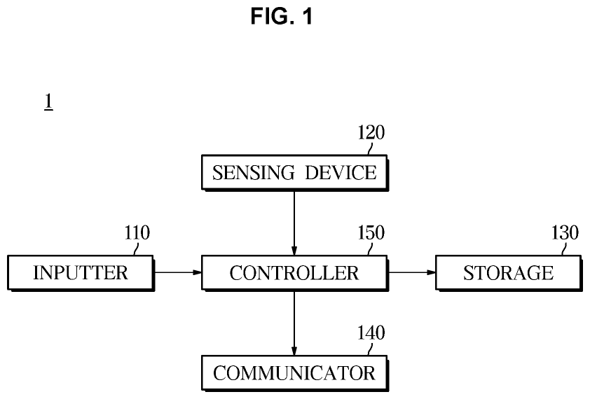

FIG. 1 is a control block diagram of a vehicle according to an exemplary embodiment of the present invention.

Referring to FIG. 1, a vehicle 1 may include an inputter 110, a communicator 140, a storage 130, a detecting device 120, and a controller 150.

The communicator 140 may receive a position signal. The position signal may include a Global Positioning System (GPS) signal. The vehicle 1 may receive a signal from a satellite and determine a current position of the vehicle 1.

The storage 130 may store map information.

The map information may provide surrounding information that the vehicle 1 drives. The map information may include road information on which the vehicle 1 is driving, information necessary for determining a position of the vehicle 1, such as position of the surrounding buildings, road facilities such as traffic lights and signs.

The storage 130 may be implemented as at least one of a non-volatile memory device (for example, a cache, Read Only Memory (ROM), Programmable ROM (PROM), Erasable Programmable ROM (EPROM), Electrically Erasable Programmable ROM (EEPROM), and flash memory), a volatile memory device (for example, Random Access Memory (RAM)), or storage medium, such as Hard Disk Drive (HDD) and Compact Disc Read Only Memory (CD-ROM), although not limited to these. The storage 130 may be a memory implemented as a separate chip from a processor with respect to the controller 150, or may be integrated as a single chip with the processor.

The inputter 110 may be provided in a configuration in which a driver inputs a command. The inputter 110 may include hardware devices such as various buttons or switches, pedals, keyboards, mice, track-balls, levers, handles, or sticks for input. The detecting device 120 may obtain the surrounding information related to the vehicle 1.

The detecting device 120 may Light Detection And Ranging (LiDAR) that emits a laser pulse, receives and light reflected from a surrounding object to measure a distance to the object, precisely deriving the surroundings, a radar that emits an electromagnetic wave to the object, receives the electromagnetic wave reflected from the object, derives the distance, a direction, and an altitude with respect to the object, and a camera for obtaining an image signal.

The surrounding information acquired by the detecting device 120 may include lane information related to the road on which the vehicle 1 drives, building information related to the surroundings, information related to a positional relationship between the vehicle 1 and a fixture including the road facilities and the like.

The controller 150 may determine a predicted position of the vehicle 1 based on the map information and the surrounding information.

The predicted position may be information derived from the vehicle 1 by comparing a pre-stored map information in the vehicle 1 with the surrounding information obtained by the vehicle 1. The controller 150 may determine a precise position based on the predicted position and the position signal received through the communicator 140. The precise position may refer to information derived from the above-described predicted position by further including the position signal. The predicted position and the precise position will be described in detail later.

The controller 150 may control the vehicle 1 to make the driving that reduces the difference between the predicted position and the precise position. The precise position may be a more accurate position than the predicted position as the derived position information by further considering the position signal at the predicted position. Therefore, to derive the accurate position, the controller 150 may control the vehicle 1 to make the driving that reduces the difference between the predicted position and the precise position.

The controller 150 may control the vehicle 1 to follow a reference element of the surrounding information based on the difference between the predicted position and the precise position and the position signal.

The reference element of the surrounding information may be an element which is a reference for deriving the position of the vehicle 1, and may refer to the lane information related to the road on which the vehicle 1 drives, building information related to the surroundings, the fixture including the road facilities, and the like.

The controller 150 may control the vehicle 1 to follow a surrounding vehicle driving around the vehicle 1 based on the difference between the predicted position and the precise position and determine at least one of the predicted position or the precise position based on the positional relationship between the vehicle 1 and the surrounding vehicle.

The surrounding information described above may include the vehicle 1 and the surrounding vehicle that drives. In the case where there is a plurality of surrounding vehicles relatively, accuracy of the position of the vehicle 1 is increased, so that the controller 150 may control the vehicle 1 to follow the surrounding vehicle.

The controller 150 may control the vehicle 1 to make the driving that reduces the difference between the predicted position and the precise position when it is determined that control rights of the vehicle 1 is changed based on a driver's command inputted from the inputter 110.

When the driver's command including a driver's autonomous driving intention is input, such as when the driver does not grasp a steering wheel and the driver inputs an autonomous driving command, the controller 150 may control the vehicle 1 to make the driving that reduces the difference between the predicted position and the precise position to improve the accuracy of the position of the vehicle 1.

The controller 150 may control the vehicle 1 to make the driving that reduces the difference between the predicted position and the precise position when an intensity of the signal received by the communicator 140 is less than a predetermined value.

When the intensity of the signal received by the communicator 140 is less than the predetermined value, it is difficult for the vehicle 1 to enter a tunnel or the like to receive the surrounding signals. In the instant case, the controller 150 may determine that it is difficult to derive accurate position information, and may control the vehicle 1 to make the driving that reduces the difference between the predicted position and the precise position.

The controller 150 may control the vehicle 1 to make the driving that reduces the difference between the predicted position and the precise position when the obtained amount of the reference element which is a reference for determining the surrounding information is less than the predetermined value.

The controller 150 may determine that the surrounding information for deriving the position of the vehicle 1 around the vehicle 1 is insufficient when the obtained amount of the reference element which is the reference for determining the surrounding information is less than the predetermined value. Thus, the controller 150 may control the vehicle 1 to make the driving that reduces the difference between the predicted position and the precise position. According to various aspects of the present invention, the driving that reduces the difference between the predicted position and the precise position may include the driving following the reference element of the surrounding information.

The controller 150 may determine the position information related to the vehicle 1 based on the predicted position and the precise position.

The controller 150 may be implemented with a memory storing an algorithm to control operation of the components in the vehicle 1 or data about a program that implements the algorithm, and a processor carrying out the aforementioned operation using the data stored in the memory. The memory and the processor may be implemented in separate chips. Alternatively, the memory and the processor may be implemented in a single chip.

At least one component may be added or deleted corresponding to the performance of the components of the vehicle 1 illustrated in FIG. 1. It will be readily understood by those skilled in the art that the mutual position of the components may be changed corresponding to the performance or structure of the vehicle 1.

In the meantime, each of the components shown in FIG. 1 may be referred to as a hardware component such as software and/or a field programmable gate array (FPGA) and an application specific integrated circuit (ASIC).

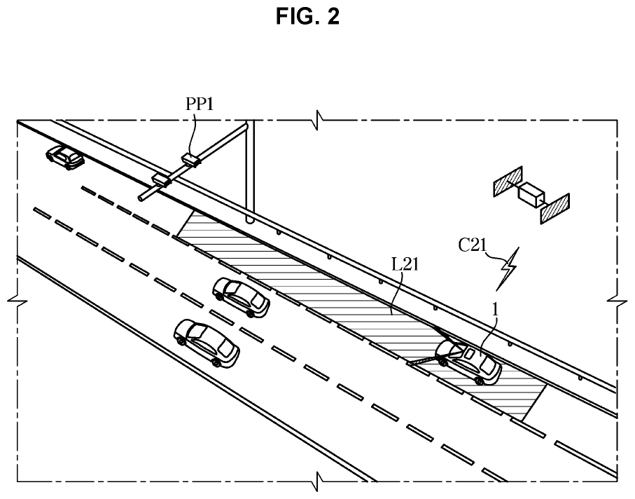

FIG. 2 is a view for describing an operation of obtaining position information related to a driving vehicle.

Referring to FIG. 2, the vehicle 1 may use the surrounding information obtained by the detecting device to derive the position information related to the vehicle 1. The vehicle 1 may use lane information L21 of the road on which the vehicle 1 drives. FIG. 2 illustrates an operation in which the vehicle 1 drives in a third lane. In the instant case, the controller 150 may determine that the vehicle 1 is driving in the third lane based on the lane information obtained by the detecting device.

Furthermore, the fixture of the road on which the vehicle 1 drives may be used to derive the position information related to the vehicle 1. In FIG. 2, a surveillance camera PP1 provided on the road is shown as the fixture. Also, the surveillance camera PP1 illustrated in FIG. 2 may be determined as the reference element of the surrounding information. That is, the controller 150 may determine the position information related to the vehicle 1 based on the positional relationship between the surveillance camera PP1 and the vehicle 1 and the pre-stored map information in the vehicle 1.

On the other hand, the vehicle 1 may determine the position information related to the vehicle 1 based on the position signal. As described above, the position signal may include a Global Positioning System (GPS) signal S21.

On the other hand, in the disclosure, the information derived from the surrounding information and the pre-stored map information in the vehicle 1 may refer to the predicted position, and the information derived by further including the position signal including the Global Positioning System (GPS) signal S21 may refer to the precise position.

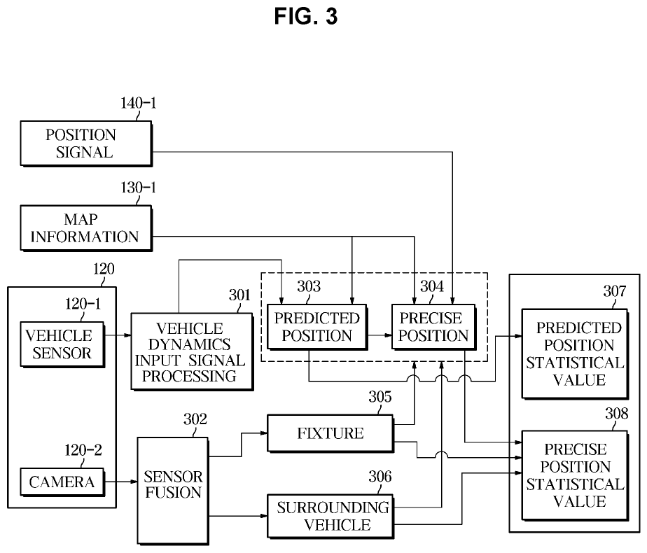

FIG. 3 is a block diagram for describing an operation of deriving a predicted position and a precise position according to an exemplary embodiment of the present invention.

Referring to FIG. 3, a position signal 140-1 may be received from the communicator 140, and map information 130-1 may be stored in the storage 130. Also, the detecting device 120 may include a vehicle sensor 120-1 and a camera 120-2. The position signal 140-1 may be used to derive the precise position as described above.

The map information may be used to derive a predicted position 303 and a precise position 304.

Meanwhile, the vehicle sensor 120-1 may include a wheel speed sensor or the like configured for obtaining speed information related to the vehicle 1 and the like, and the information obtained by the vehicle sensor 120-1 may be used to derive the predicted position 303 based on a dynamics input signal processing 301 of the vehicle 1.

Meanwhile, the camera 120-2 provided in the vehicle 1 may derive the position of the vehicle 1 based on a fixture 305 provided around the vehicle 1 and a surrounding vehicle 306.

The camera 120-2 may derive the positional relationship between the fixture 305 provided around the vehicle 1 through a sensor fusion 302 and surrounding vehicle 306 and the vehicle 1, and derived positional relationship may derive the predicted position 303 and the precise position 304 of the vehicle 1 by comparing with the map information.

Meanwhile, the predicted position 303 and the precise position 304 derived based on the above-described method may be determined by use of a predicted position statistical value 307 and a precise position statistical value 308, respectively, and the controller 150 may determine the stability of a positioning that determined the position of the vehicle 1 based on the statistical values 307 and 308.

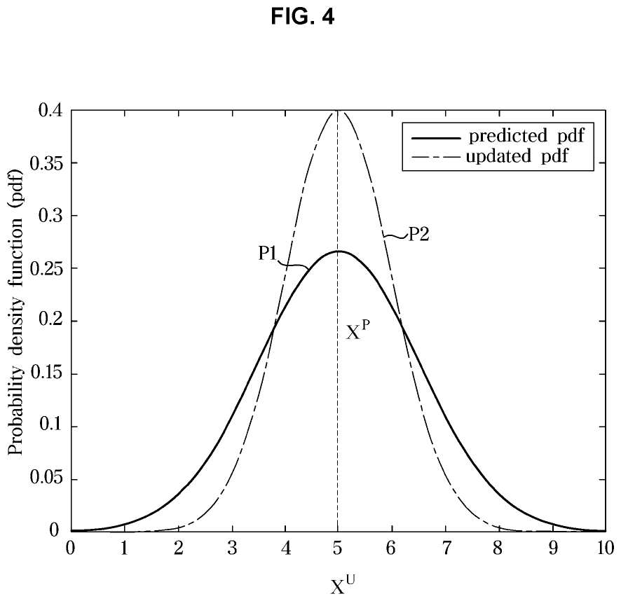

FIG. 4 is a view for describing an operation of deriving the difference between a predicted position and a precise position according to an exemplary embodiment of the present invention.

Referring to FIG. 3 and FIG. 4, the controller 150 may determine the difference between the predicted position 303 and the precise position 304 by comparing the predicted position statistical value 307 and the precise position statistical value 308. The determination may be derived through the following Equation 1.

$$D = \frac{p ( Xu \vert Xp )}{p ( Xu \vert Xp , Z 1 , Z 2 , Z 3 … L )} \qquad [ Equation 1 ]$$

Referring to Equation 1, Xu may denote the position of the vehicle 1, Xp may denote the predicted position 303. p (Xu|Xp) is a conditional probability density function, which may be the accuracy of the position of the vehicle 1 in a predicted position condition.

On the other hand, p (Xu|Xp, Z1, Z2, Z3 . . . L) may be defined as the conditional probability density function which denotes the position of the vehicle 1 relative to the precise position 304.

On the other hand, as the vehicle 1 performs accurate and stable positioning, p (Xu|Xp) may decrease and p (Xu|Xp, Z1, Z2, Z3. L) may increase. As the vehicle 1 performs an unstable positioning, p (Xu|Xp) may increase and p (Xu|Xp, Z1, Z2, Z3. L) may decrease.

Accordingly, the controller 150 may determine that the positioning is stable when D is less than the predetermined value based on the Equation 1, and may determine that the positioning is unstable when the D is greater than the predetermined value.

A probability distribution P1 of the predicted position 303 may have a large variance value because a probability value of the position is widely distributed. On the other hand, a probability distribution P2 of the precise position 304 is relatively narrower than the predicted position 303 and have a low variance value.

Meanwhile, when the D is greater than the predetermined value, the controller 150 may determine that the positioning is unstable, and improve the accuracy of the positioning to adjust the D to the predetermined value or less. According to various aspects of the present invention, According to various aspects of the present invention the, the controller 150 may control the vehicle 1 to follow the fixture 305 or the like which is the reference element of the surrounding information related to the vehicle 1.

FIG. 3 and FIG. 4 are merely examples for describing the operation of the disclosure. The operation for evaluating the stability of a vehicle positioning may be improved by utilizing various fault detection (FDI) algorithms (SPRT, CUSUM, GLR, etc.), and the operation is not limited as long as the operation for evaluating the accuracy of vehicle position measurement.

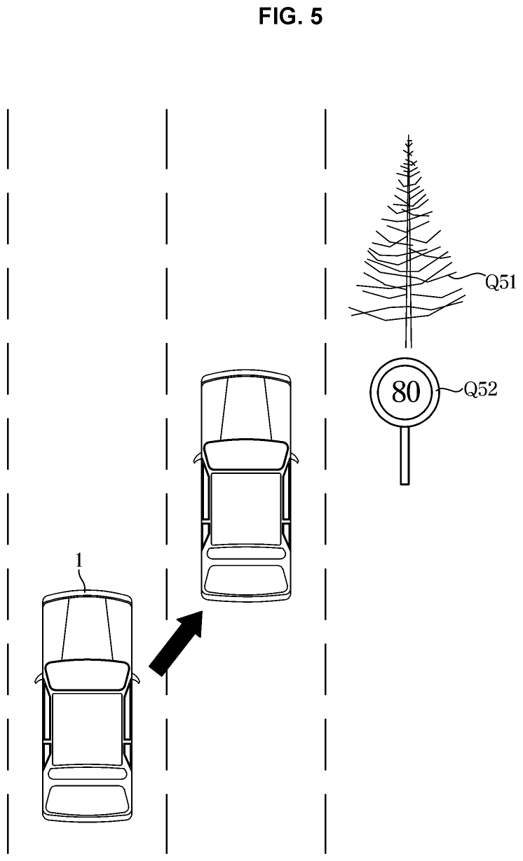

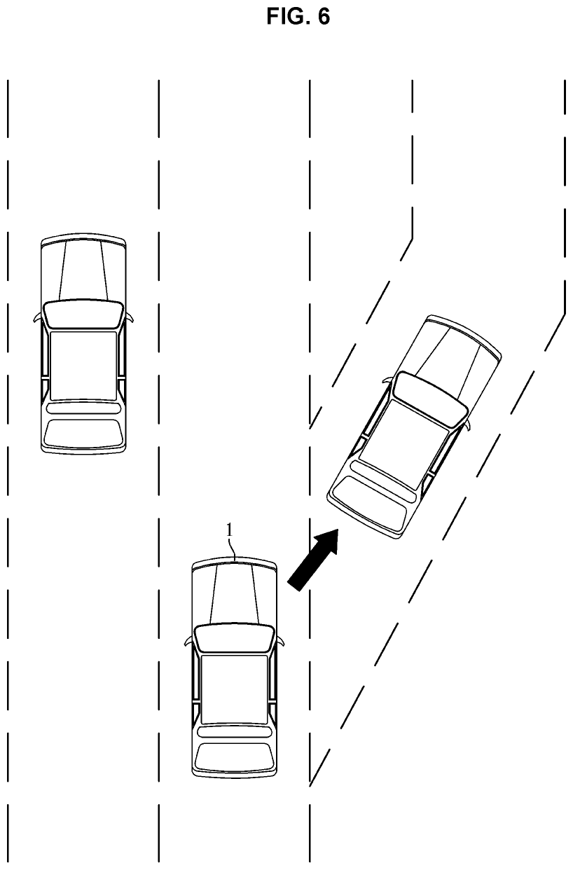

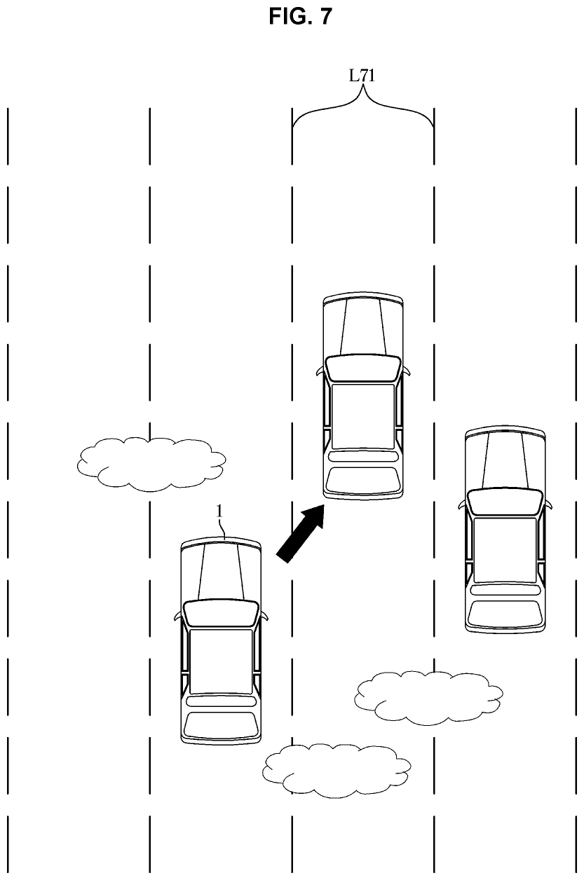

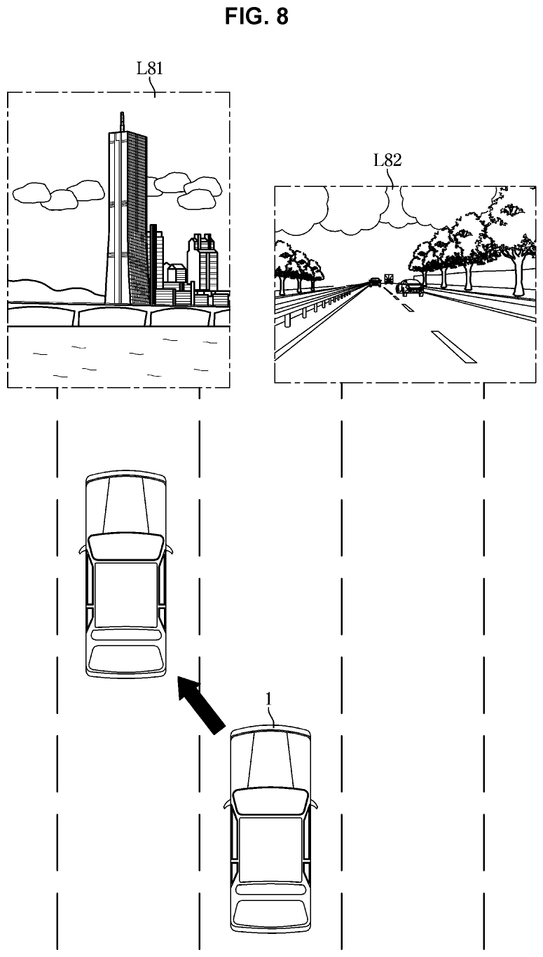

FIGS. 5 to 8 are views for describing a driving operation for reducing the difference between a predicted position and a precise position.

As described above, the position of the vehicle 1 may be derived by the surrounding information related to the vehicle 1, and the surrounding information related to the vehicle 1 may be determined based on the reference element of the surrounding information.

FIG. 5 illustrates that the vehicle 1 drives to one of the surrounding fixtures Q51 and Q52 of the reference element. In conditions where precise positioning of the vehicle 1 is required and where the precise positioning of the vehicle 1 is difficult, the controller 150 may be controlled to follow the reference element of the surrounding information to obtain accurate surrounding information.

Therefore, the vehicle 1 may drive on existing roads by moving to the more a second lane of the fixtures Q51 and Q52.

In FIG. 6, it is illustrated that the vehicle 1 drives on a path having road characteristics such as IC/JC, which is one of the reference elements. In conditions where the precise positioning of the vehicle 1 is required and where the precise positioning of the vehicle 1 is difficult, the controller 150 may control to follow the path with the road characteristics to obtain accurate surrounding information.

Therefore, the vehicle 1 may drive on the third lane to follow IC/JC on existing roads.

FIG. 7 illustrates that lane information L71, which is one of the reference elements, drives on a correct path. In conditions where the precise positioning of the vehicle 1 is required and where the precise positioning of the vehicle 1 is difficult, the controller 150 may control to follow the lane information L71 to follow the correct path to obtain accurate surrounding information.

In FIG. 7, it is difficult to obtain accurate lane information because the lane is covered by a material on the lane at the current position, so that the controller 150 may obtain the lane information L71 by moving the vehicle 1 from the second lane to the third lane, the surrounding information may be derived and the position of the vehicle 1 may be accurately derived.

FIG. 8 illustrates that the vehicle 1 drives on a landmark L81 which is one of the reference elements. In conditions where the precise positioning of the vehicle 1 is required and where the precise positioning of the vehicle 1 is difficult, the controller 150 may control to follow the path where the landmark L81 is present to obtain accurate surrounding information.

That is, when the vehicle 1 drives in the second lane or the third lane in FIG. 8, there is no landmark in the surrounding (L82). Therefore, the controller 150 may control the vehicle 1 to drive on a first lane where the landmark L81, the reference element of the surrounding information, is present.

FIGS. 5 to 8 are merely examples of the disclosure, and there is no restriction on the operation of the vehicle 1 related to the driving that follows the reference element necessary for deriving the surrounding information.

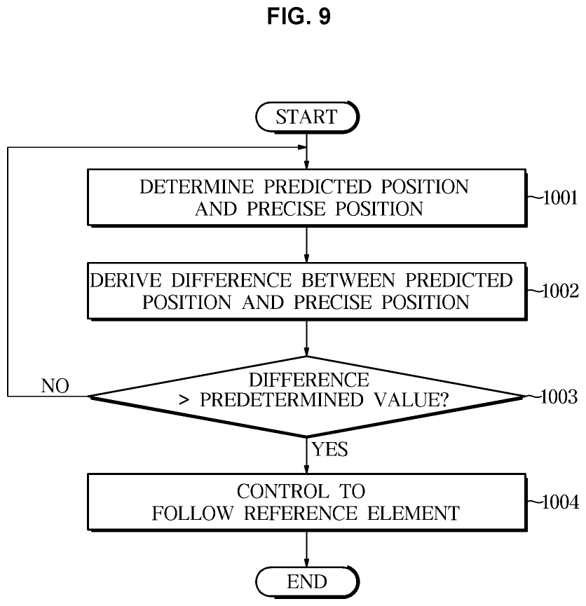

FIG. 9 is a flowchart according to an exemplary embodiment of the present invention.

Referring to FIG. 9, the controller 150 may determine the predicted position 303 and the precise position 304 of the vehicle 1 (1001). The controller may derive the difference between the predicted position 303 and the precise position 304 (1002). The difference between the predicted position 303 and the precise position 304 may be derived from the comparison of the above probability distributions. Meanwhile, when the difference between the predicted position 303 and the precise position 304 exceeds the predetermined value (1003), the controller 150 may control to follow the reference element of the surrounding information related to the vehicle 1 (1004).

As is apparent from the above description, the disclosure may precisely determine the position of the vehicle through the driving path leading to accurate positioning of the vehicle and perform the safe autonomous driving.

Meanwhile, the disclosed exemplary embodiments may be implemented in a form of a recording medium storing instructions that are executable by a computer. The instructions may be stored in a form of a program code, and when executed by a processor, the instructions may generate a program module to perform operations of the included exemplary embodiments. The recording medium may be implemented as a computer-readable recording medium.

The computer-readable recording medium may include all kinds of recording media storing commands which may be interpreted by a computer. For example, the computer-readable recording medium may be ROM, RAM, a magnetic tape, a magnetic disc, flash memory, an optical data storage device, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “internal”, “external”, “inner”, “outer”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. A vehicle comprising:
a communicator;
a storage configured to store map information;
a detecting device configured to detect driving information related to the vehicle and surrounding information related to the vehicle; and
a controller configured to:
determine a predicted position of the vehicle based on the map information, the driving information, and the surrounding information;
determine a precise position based on the predicted position and a position signal received through the communicator; and
control the vehicle to make a driving that reduces a difference between the predicted position and the precise position.

2. The vehicle according to claim 1, wherein the controller is configured to control the vehicle to follow a reference element of the surrounding information based on the difference between the predicted position, the precise position and the position signal.

3. The vehicle according to claim 2, wherein the controller is configured to:
control the driving of the vehicle following a surrounding vehicle driving around the vehicle based on the difference between the predicted position and the precise position; and
determine at least one of the predicted position or the precise position based on a positional relationship between the vehicle and the surrounding vehicle.

4. The vehicle according to claim 2, wherein the controller is configured to:
determine a position of a fixture included in the reference element based on at least one of the map information or the position signal; and
control the vehicle to follow the fixture and make the driving that reduces the difference between the predicted position and the precise position.

5. The vehicle according to claim 2, wherein the controller is configured to:
determine road characteristics around the vehicle based on at least one of the map information or the position signal; and
control the vehicle to follow a lane in which a predetermined road characteristic exists and make the driving that reduces the difference between the predicted position and the precise position.

6. The vehicle according to claim 1, further including:
an inputter configured to input a driver's command to the controller,
wherein the controller connected to the inputter is configured to control the vehicle to make the driving that reduces the difference between the predicted position and the precise position upon determining that control rights of the vehicle is changed based on the driver's command.

7. The vehicle according to claim 1, wherein the controller is configured to control the vehicle to make the driving that reduces the difference between the predicted position and the precise position upon determining that an intensity of a signal received by the communicator is less than a predetermined value.

8. The vehicle according to claim 1, wherein the controller is configured to control the vehicle to make the driving that reduces the difference between the predicted position and the precise position upon determining that an obtained amount of a reference element which is a reference for determining the surrounding information is less than a predetermined value.

9. The vehicle according to claim 1, wherein the controller is configured to determine position information related to the vehicle based on the predicted position and the precise position.

10. A method of controlling a vehicle, the method comprising:
detecting, by a detecting device, surrounding information related to the vehicle;
determining, by a controller, a predicted position of the vehicle based on map information and the surrounding information;
determining, by the controller, a precise position based on the predicted position and a received position signal; and
controlling, by the controller, the vehicle to make a driving that reduces a difference between the predicted position and the precise position.

11. The method according to claim 10, wherein the controlling of the vehicle to make the driving that reduces the difference between the predicted position and the precise position includes:
controlling the vehicle to follow a reference element of the surrounding information based on the difference between the predicted position and the precise position and the position signal.

12. The method according to claim 11, wherein the controlling of the vehicle to make the driving that reduces the difference between the predicted position and the precise position further includes:
controlling the driving of the vehicle following a surrounding vehicle driving around the vehicle based on the difference between the predicted position and the precise position, and
wherein the determining of the precise position based on the predicted position and the received position signal includes:
determining at least one of the predicted position or the precise position based on a positional relationship between the vehicle and the surrounding vehicle.

13. The method according to claim 11, wherein the controlling of the vehicle to make the driving that reduces the difference between the predicted position and the precise position further includes:
determining a position of a fixture included in the reference element based on at least one of the map information or the position signal; and
controlling the vehicle to follow the fixture and make the driving that reduces the difference between the predicted position and the precise position.

14. The method according to claim 11, wherein the controlling of the vehicle to make the driving that reduces the difference between the predicted position and the precise position further includes:
determining road characteristics around the vehicle based on at least one of the map information or the position signal; and
controlling the vehicle to follow a lane in which a predetermined road characteristic exists and make the driving that reduces the difference between the predicted position and the precise position.

15. The method according to claim 10, further including:
receiving, by the controller, a driver's command,
wherein the controlling of the vehicle to make the driving that reduces the difference between the predicted position and the precise position includes:
controlling the vehicle to make the driving that reduces the difference between the predicted position and the precise position upon determining that control rights of the vehicle is changed based on the driver's command.

16. The method according to claim 10, wherein the controlling of the vehicle to make the driving that reduces the difference between the predicted position and the precise position includes:
controlling the vehicle to make the driving that reduces the difference between the predicted position and the precise position upon determining that an intensity of a signal received by the communicator is less than a predetermined value.

17. The method according to claim 10, wherein the controlling of the vehicle to make the driving that reduces the difference between the predicted position and the precise position includes:
controlling the vehicle to make the driving that reduces the difference between the predicted position and the precise position upon determining that an obtained amount of a reference element which is a reference for determining the surrounding information is less than a predetermined value.

18. The method according to claim 10, further including:
determining position information related to the vehicle based on the predicted position and the precise position.
